(19) United States
(12) Patent Application Publication
(10) Pub. No.: US 2015/0268838 A1
(43) Pub. Date: Sep. 24, 2015

(54) METHODS, SYSTEMS, ELECTRONIC DEVICES, AND NON-TRANSITORY COMPUTER READABLE STORAGE MEDIUM MEDIA FOR BEHAVIOR BASED USER INTERFACE LAYOUT DISPLAY (BUILD)

(71) Applicant: Institute For Information Industry, Taipei (TW)

(72) Inventors: Wen-Nan WANG, New Taipei City (TW); Chien-Ting KUO, Taichung City (TW); Cheng-Yuan HO, Taipei City (TW); Feng-Sheng WANG, Tainan City (TW); Ai Ting CHANG, New Taipei City (TW); Stephen HSU, Taipei City (TW); Louis Lu-Chen HSU, Taipei City (TW)

(73) Assignee: Institute For Information Industry, Taipei (TW)

(21) Appl. No.: 14/220,312

(22) Filed: Mar. 20, 2014

(51) Int. Cl. G06F 3/0484; H04M 1/725

(52) U.S. Cl. CPC G06F 3/04847; H04M 1/72583; G06F 3/04842

(57) ABSTRACT

A method, system, electronic device, and non-transitory computer readable storage medium for behavior based user interface layout display are provided. The method includes: displaying service information on an user interface in the form of a first layout arrangement with a first set of components, receiving a service information request from the user interface, establishing an user profile based on the service information request, reconfiguring the service information based on the user profile, and displaying the reconfigured service information on the user interface in the form of a second layout arrangement with a second set of components. A size of each of the first set and the second set of the components is variable.

### FIELD

The disclosed embodiments relate to methods, systems, electronic devices, and non-transitory computer readable storage media for displaying/presenting a user interface, and more particularly, for a behavior based user interface layout display (BUILD).

### BACKGROUND

Electronic devices, such as desktop computers, laptops, Smartphones, tablets, or other portable devices, have become more and more popular in recent years. The electronic devices such as cell phones may provide multiple functions, for example cellular phone service, message service, application programs, email access, and accessibility of internet service. Users may utilize such functions for various purposes. The electronic devices may provide a touch screen, including a display, which allows users to operate such functions on the display easily.

With increasing utility and complexity of functions or application programs on the electronic devices, user interfaces of those functions or application programs have been designed for allowing users to manipulate those functions on the display. Most conventional designs of user interface object or user interface layout are not sufficiently user friendly.

In some application programs, the user interface layout may be a template with a set of objects provided by a third party and those objects of the templates are offered in a fixed layout, such as fix sized icons with predetermined categories or layers.

Some layouts lack capability for allowing a user to customize and personalize, and others may not be dynamically updated based on users' preferences or behaviors. For example, the front page of browsers (i.e. Google Chrome, Microsoft IE) comprises a fixed number of browsed page snapshots which are ordered in a sequence according to usage frequency. However, those snapshots do not provide hierarchical or category levels neither provide any user friendly visual effects. The user only has very limit capability to manipulate the arrangement of the snapshots. As a result, those snapshot layouts can not allow users to access needed information or service more efficiently.

### SUMMARY

The disclosed embodiments include methods, systems, electronic devices, and non-transitory computer readable storage media for Behavior based User Interface Layout Display (BUILD).

The method for BUILD according to certain embodiments comprises: (a) displaying service information on a user interface in the form of a first layout arrangement with a first set of components, (b) receiving a service information request from the user interface, (c) establishing a user profile based on the service information request, (d) reconfiguring the service information based on the user profile, and (e) displaying the reconfigured service information on the user interface in the form of a second layout arrangement with a second set of components, wherein a size of each of the first set and the second set of the components is variable.

The electronic device with BUILD according to certain embodiments comprises an input device, a memory unit, an output device, and a processor. The input device is for receiving the service information request. The memory unit is for storing a plurality of program routines and comprises an establisher and a reconfigurer. The establisher is for establishing the user profile based on the service information request, while the reconfigurer is for reconfiguring the service information in form of a layout arrangement based on the user profile. The output device is for presenting the reconfigured service information. The processor is coupled to the input device, the output device, and the memory unit for executing the program routines.

Another electronic device with BUILD according to certain embodiments comprises an input device, a processor, and an output device. The input device is for receiving the service information request. The processor is coupled to the input device and comprises an establisher and a reconfigurer. The establisher is for establishing the user profile based on the service information request, while the reconfigurer is for reconfiguring service information in form of a layout arrangement based on the user profile. The output device is coupled to the processor and for presenting the reconfigured service information.

The non-transitory computer readable storage medium according to certain embodiments stores program routines for causing an electronic device to perform a method comprising: (a) displaying service information on a user interface in the form of a first layout arrangement, (b) receiving a service information request from the user interface, (c) establishing a user profile based on the service information request, (d) reconfiguring the service information based on the user profile, and (e) displaying the reconfigured service information on the user interface in the form of a second layout arrangement.

The detailed technology implemented in the disclosure are described in the following paragraphs accompanying the appended drawings for people skilled in this field to well appreciate the features of the claimed disclosure.

### BRIEF DESCRIPTION OF THE DRAWINGS

FIG. 1 is a flow diagram illustrating an embodiment of a method for BUILD;

FIG. 2 is a sequential diagram of a hierarchical layout arrangement;

FIG. 3 is a diagram illustrating components presented in different shapes;

FIG. 4 is a diagram of an exemplary user profile;

FIG. 5 is a block diagram of an electronic device with BUILD system according to some embodiments;

FIG. 6 is a block diagram of an electronic device with BUILD system according to some other embodiments;

FIG. 7 illustrates a set of sequential layout arrangements;

FIG. 8 shows another set of sequential layout arrangement whose components are resized or hidden in a manual mode;

FIG. 9 is a block diagram of an exemplary resizing process for updating one component (or components) of a layout arrangement;

FIG. 10 is a flow diagram of an algorithm for updating a displayed size of at least one component of at least one layout arrangement;

FIG. 11 is a diagram showing 3 sets of sequential layout arrangements;

FIG. 12 is a set of diagrams according to a phone directory embodiment for recall and share action in a manual mode;

FIG. 13 is a set of diagrams showing layout arrangements of a location based service information embodiment; and

FIG. 14 is a set of sequential diagram showing layout arrangement of location-based service according to another embodiment.

### DETAILED DESCRIPTION

In the following description, methods, systems, electronic devices, and non-transitory computer readable storage media for behavior based user interface layout display (BUILD) will be explained with reference to example embodiments thereof. However, these example embodiments are not intended to limit the present disclosure to any examples, embodiments, environments, applications, or implementations described herein. Therefore, the description of these example embodiments is only for the purpose of illustration rather than to limit the scope of the present disclosure. It shall be appreciated that in the following embodiments and attached drawings, elements not directly related to the present disclosures are omitted from depiction.

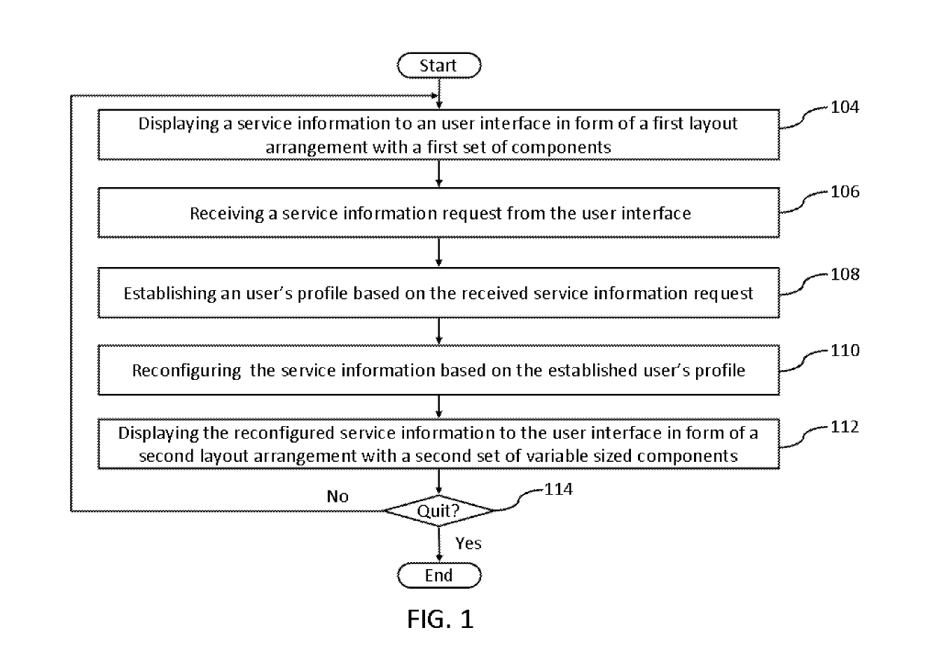

A first embodiment of the present disclosure is a method for BUILD, whose flowchart is illustrated in FIG. 1. The method may be executed by a computing apparatus, such as a system and/or an electronic device that will be described later in the descriptions.

Initially, the method is executed for displaying service information (e.g. a preset service information) on a user interface (e.g. shown on a mobile device touch screen) in the form of a first layout arrangement with a first set of components (e.g. icons, tiles, objects, snapshots, pictures, windows, frames, etc.) (stage 104). The service information may comprise at least one piece of location-based, temporal-based, social-based, and/or event-based service information. Next, the method is executed for receiving a service information request from the user interface, wherein the service information request may be triggered by a user (stage 106). For example, this may be executed by the user via a receiver (e.g. a vocal input component, a touch screen component, or other types of sensors) of the computing apparatus. The details of the service information request will be given later.

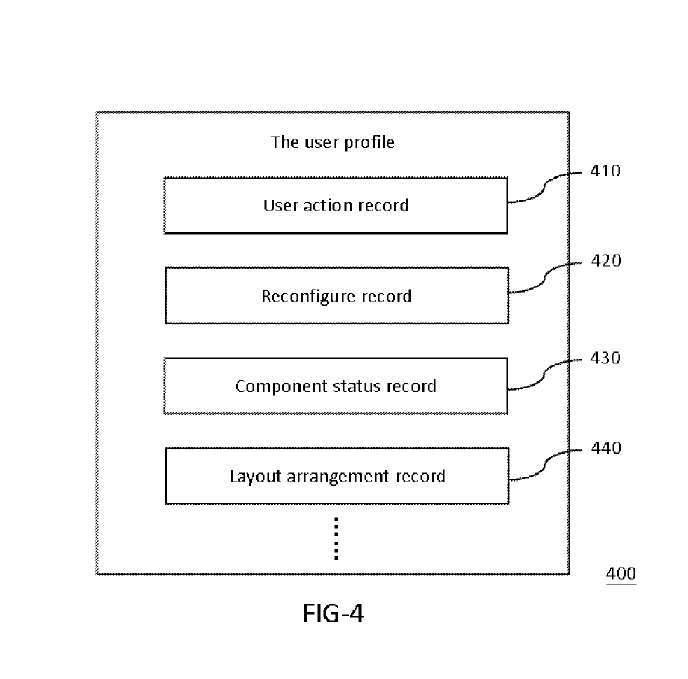

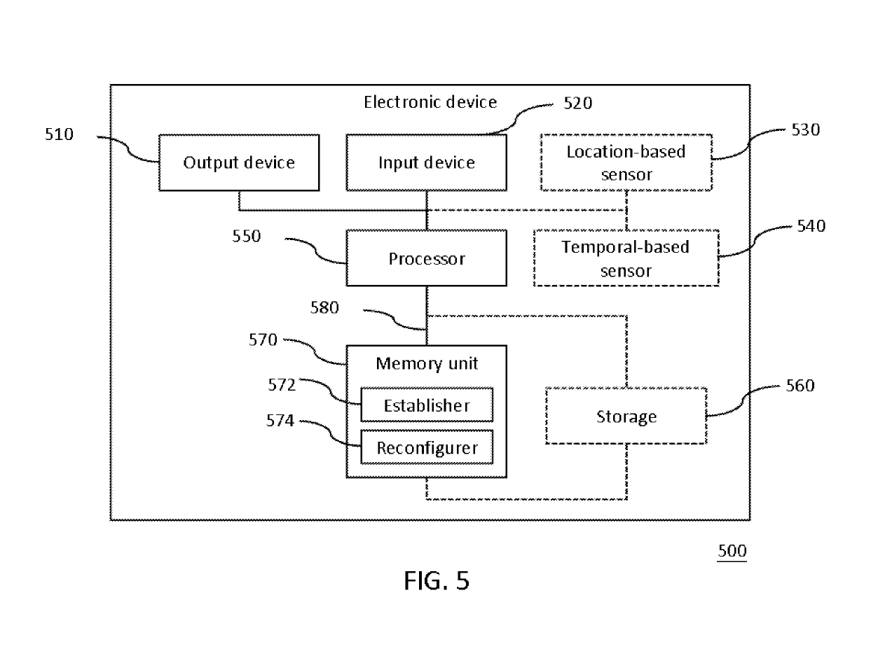

Following that, the method is executed for establishing a user profile based on the service information request received in stage 106 (stage 108). Please refer to FIG. 4 for an example of the user profile 400 established in this stage, which may be stored in the storage 560 of the electronic device 500 shown in FIG. 5. The details of the user profile 400 will be given later.

Next, the method is executed for reconfiguring the service information based on the user profile (stage 110). Then, the method is executed for displaying the reconfigured service information on the user interface in the form of a second layout arrangement with a second set of components (stage 112).

Afterwards, determining whether a signal indicating quitting is received is executed (stage 114). If affirmative, the method terminates; otherwise, the method repeats the stages 104-114. It is noted that a displayed size of at least one of the components is variable and may be from a predetermined minimum size to a predetermined maximum size.

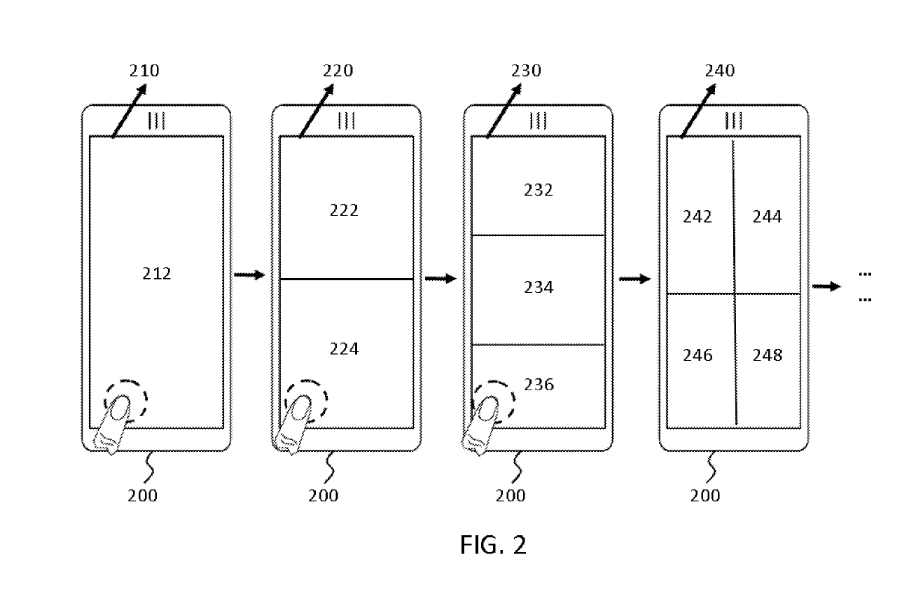

FIG. 2 illustrates a sequential diagram of exemplary hierarchical layout arrangements for an electronic device such as a Smartphone 200. Different levels of the layout arrangements 210, 220, 230, and 240 are shown on the user interface according to one exemplary embodiment of the present disclosure. That is, each of the layout arrangements 210, 220, 230, and 240 is presented with at least one hierarchical level.

Initially, the user interface of the Smartphone 200 is displayed with a service information in form of a layout arrangement 210 with a set of component 212. After the Smartphone 200 receives a service information request from user interface (e.g. a signal generated when a user touches the component 212, slides the component 212, as illustrated by a finger touch to a dashed circle, etc.), the user interface changes from displaying the layout arrangement 210 to displaying the layout arrangement 220. That is, the layout arrangement 220 is the next level of the layout arrangement 210 when the component 212 is selected. The layout arrangement 220 is with the components 222 and 224. After receiving another service information request (e.g. a signal generated when a user touches/slides the component 224) from user interface, the user interface changes from displaying the layout arrangement 220 to displaying the layout arrangement 230. That is, the layout arrangement 230 is the next level of the layout arrangement 220 when the component 224 is selected. The layout arrangement 230 includes the components 232, 234, and 236. After receiving yet another service information request (e.g. a signal generated when a user touches/slides the component 236) from user interface, the user interface changes from displaying the layout arrangement 230 to displaying the layout arrangement 240. That is, the layout arrangement 240 is the next level of the layout arrangement 230 when the component 236 is selected. The layout arrangement 240 includes the components 242, 244, 246, and 248.

Although the components 212, 222, 224, 232, 234, 236, 242, 244, 246, 248 are presented in the rectangular shapes, the shape are not limited herein. The components 212, 222, 224, 232, 234, 236, 242, 244, 246, 248 may be presented with the content, a picture, or the combination thereof.

A concrete example is given here. It is assumed that the layout arrangement 210 represents user's telephone directory. In other words, the service information is related to telephone directory. When the component 212 is touched by the user, the display will be changed to the layout arrangement 220 which has two components 222 and 224. In this example, the component 222 may represent user's family phone list, while the component 224 may represent user's co-workers' phone list. Now, if user tries to look for a co-worker and hit the component 224, then the display will be changed from the layout arrangement 220 to the layout arrangement 230 that comprises three components 232, 234, 236. In this example, each of the components 232, 234, 236 is a category of co-worker, which may indicate three different departments at work. User can continue to look for a person in certain department, and so on.

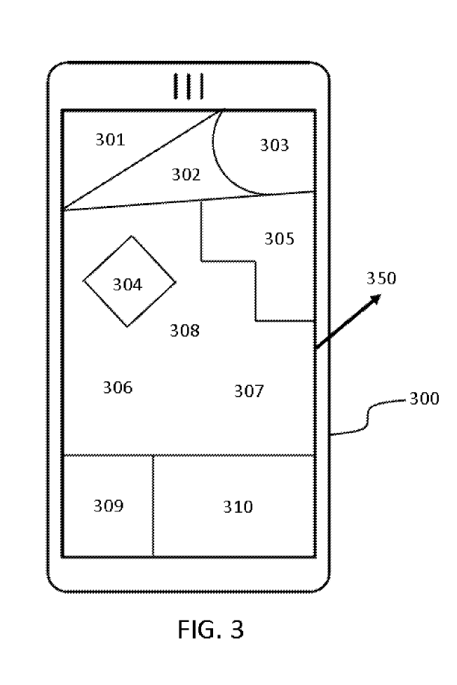

FIG. 3 is a diagram illustrating components presented in different shapes. In this example, the Smartphone 300 displays a service information (or a reconfigured service information) to an interface in form of the layout arrangement 350 according to one exemplary embodiment of present disclosure. The layout arrangement 350 is with the components 301, 302, 303, 304, 305, 306, 307, 308, 309, and 310. Each of the components 301, 302, 303, 304, 305, 306, 307, 308, 309, and 310 is in a geometry shape of a square, a rectangle, a circle, a polygon, a diamond, a trapezoid, a parallelogram, a triangle, an oval, and a combination thereof. It is noted that the components 301, 302, 303, 304, 305, 306, 307, 308, 309, and 310 may be in different geometry shapes or may be in the same geometry shape. It is also possible that only several of the components 301, 302, 303, 304, 305, 306, 307, 308, 309, and 310 are in the same geometry shape.

In some other embodiments, the components of a layout arrangement may be presented with different colors, different gray scales, different sizes, different 2D or 3D dimensions, and so on.

FIG. 4 illustrates an exemplary user profile 400 in this embodiment. As addressed, the user profile 400 may comprise a user action record 410, a reconfigure record 420, a component status record 430, and a layout arrangement record 440. These records 410, 420, 430, 440 may be dependent on or independent of each other.

It should be appreciated that the user profile 400 is only an example and is not used to limit the scope of the disclosure. The user profile 400 may comprise more or fewer records than those shown in FIG. 4. The user profile 400 may combine two or more of the records 410, 420, 430, 440. In addition, different representations or arrangements of the records 410, 420, 430, 440 are not excluded from this proposal. The user profile 400 and the records 410, 420, 430, and 440 shown in FIG. 4 may be implemented in hardware (e.g., a cache, a ROM, a Flash memory, and/or a disk), software (e.g., a storage and a space), or a combination of both hardware and software, e.g. firmware.

The user action record 410 is responsible for recording any action (i.e. the service information request) from a user. For example, the service information request may include an action of sending multimedia message(s), exchanging short message(s), and/or the like. Yet as another example, the service information request may include a user-behavior request, a physical operation on the user interface, a sensing action performed by a sensor, and/or the like.

When the service information request is a user-behavior request, it may be a querying action (e.g. the user queries a name of a restaurant to find the address in the BUILD via a user interface (UI) of a Smartphone, etc), a browsing action, and/or a dialing action. Or, user may program GPS in the phone to drive to some locations, or use phone to order a ticket or merchant, etc. When the service information request is a physical operation on the user interface, it may be a control action, a sound-related signal, an image-related signal, and/or other signal received from the user interface. To be more specific, the control action may be a clicking action (e.g. the user clicks the address of a restaurant shown on the Smartphone to see where it is), a zooming action (e.g. the user zooms in/out the map to get the whole picture), a sliding action, and/or other touching action. The sound-related signal may be a received voice signal, a received sound signal, a received ultrasound signal, a received gesture signal, and/or the like. The image-related signal may be a captured image, captured graphics, and/or the like. The other signal received from the user interface may be a received light signal, a radio frequency signal, movement, and/or the like. When the service information request is a sensing action performed by a sensor, it may be a request signal triggered by a location-based sensor, a G-sensor, and/or the like.

In some embodiments, the service information request may be an action performed to components of a set of a layout arrangement. For example, the service information request may be hiding one of the components of the set, adding a new component to the set, resizing one of the components, deleting one of the components from the set, recalling a hidden component to the set, sharing the layout arrangement, and a combination thereof. The details of the hiding, adding, resizing, deleting, recalling, sharing actions will be described later.

The reconfigure record 420 is used to log the changes from the actions (i.e. the service information request), location-based service information, temporal-based service information, social-based service information, event-based service information from related sensors, and/or the like.

The component status record 430 is responsible for recording all information of each of the components, such as size, color, gray scale, geometry shape, position, dimensions, and so on. In some embodiments, a displayed size of each component is set to a value from a predetermined minimum size to a predetermined maximum size, so the component status record 430 also records the predetermined minimum size and the predetermined maximum size. In some embodiments, a number of the components displayed to the user interface is from a predetermined minimum value to a predetermined maximum value, so the component status record 430 also records the predetermined minimum and the predetermined maximum number. In some embodiments, each layout arrangement is presented with at least one category and/or at least one hierarchical level, so the component status record 430 also records the category (or categories) and/or hierarchical level (or hierarchical levels), etc.

The layout arrangement description 440 is used to describing the layout arrangement of the user interface. For example, there are 10 components in the layout arrangement, where 5 components are square, 3 components are rectangle, and others are circle. These 10 components cover the entire layout arrangement, but they may or may not overlap each other. The layout arrangement description 440 may be implemented in, but not limited to, eXtensible Markup Language (XML), Hyper Text Markup Language (HTML), eXtensible HyperText Markup Language (XHTML), Extensible Stylesheet Language Transformations (XSLT), Cascading Style Sheets (CSS), Really Simple Syndication (RSS), Standard Generalized Markup Language (SGML), JavaScript file, and a combination thereof.

FIG. 5 is a block diagram of an electronic device 500 with BUILD according to some embodiments of the present disclosure. The electronic device 500 is able to perform all the aforementioned stages. The electronic device 500 comprises an output device 510, an input device 520, a processor 550, and a memory unit 570. The memory unit 570 stores a plurality of program routines, including an establisher 572 and a reconfigurer 574. In some embodiments, the program routines may be stored in any kind of non-transitory computer readable storage medium. The electronic device 500 may further comprise a location-based sensor 530, a temporal-based sensor 540, and a storage 560. The processor 550 is electrically connected to the location-based sensor 530, the temporal-based sensor 540, and the storage 560. These elements/devices within the electronic device 500 may communicate over one or more communication buses or signal lines 580.

It should be appreciated that the electronic device 500 is only one example. Besides, the electronic device 500 may comprise more or fewer elements/devices than those shown in FIG. 5, may combine two or more elements/devices, or may have a different representation, configuration, or arrangement of the elements/devices. In other words, the elements/devices with dashed lines can be used or not based on the applications and scenarios. For example, when there is no need for the location and temporal information in a scenario, the location-based sensor 530 and the temporal-based sensor 540 can be hided or omitted. The electronic device 500 and the various elements/devices shown in FIG. 5 may be implemented in hardware, software, or a combination of hardware and software, including one or more signal processing and/or application specific integrated circuits.

The output device 510 is used to present the aforementioned reconfigured service information. The output device 510 may comprise a screen of the electronic device 500, a television, a computer monitor, a head-mounted display, liquid crystals, a broadcast reference monitor, a medical monitor, a cathode ray tube display (CRT), a light-emitting diode display (LED), an electroluminescent display (ELD), an electronic paper (E-Ink), a plasma display panel (PDP), a liquid crystal display (LCD), a high-performance addressing display (HPA), a thin-film transistor display (TFT), an organic light-emitting diode display (OLED), a surface-conduction electron-emitter display (SED), a laser TV, carbon nanotubes, a quantum dot display, an interferometric modulator display (IMOD), a swept-volume display, a varifocal mirror display, an emissive volume display, a laser display, holographic display, and a light field display, and/or any transmitter like. Moreover, the output device 510 may comprise at least one display device or transmitter.

The input device 520 is for receiving the aforementioned service information request from the user. The input device 520 may comprise a touch panel, a mouse, a keyboard, a telecommunication receiver, a gesture recognizer, a voice receiver, a gyroscope, a camera, a ultrasound, a brainwave receiver, a software input (e.g., command, speech synthesis, and text-to-speech), and a combination thereof.

When the service information is location-based, the location-based sensor 530 is responsible for sensing the location of the user. The location-based sensor 530 may include a positioning system, such as a global navigation satellite system (GNSS), a global positioning system (GPS), a global navigation satellite system, a Galileo, a Beidou navigation system, an Indian regional navigational satellite system, a regional system, a long range navigation system, a site-wide system, an active bat, a workspace system, a Wii Remote with sensor bar, a Polhemus Tracker, and an interplanetary-radio communication system. The location-based sensor 530 may get location information from another system like an electronic cash register (ECR) and a point of sale (POS).

When the service information is temporal-based, the temporal-based sensor 540 is used to sense time. The temporal-based sensor 540 may be implemented in the electronic device 500, such as a desktop computer, a laptop, a Smartphone, a tablet, and a portable device. The temporal-based sensor 540 may be implemented in another device, such as a watch and a clock. The temporal-based sensor 540 may further sense valid time, which is the time period during which a fact is true with respect to the real world, transaction time, which is the time period during which a fact stored in the database is considered to be true, and bitemporal data, which combines both valid and transaction time.

The processor 550, may be a microcontroller, an ASIC controller, or a pre-programmed logic chip, which is used to execute program routines (e.g. the establisher 572 and the reconfigurer 574) for the electronic device 500 and is electrically connected to the output device 510, the input device 520, and the memory unit 570. In some embodiments, the processor 550 and the memory unit 570 may be implemented on a single chip. They may also be implemented on separate chips or separately put on individual devices in some other embodiments.

The storage 560 is for storing user profile (e.g. the user profile 400). The storage 560 may comprise one or more non-volatile random-access memory (or NVRAM), magnetic disk storage devices, optical disk storage devices, flash memory devices, or other non-volatile solid state storage devices.

The memory unit 570 stores the program routines (e.g. the establisher 572 and the reconfigurer 574). The memory unit 570 may include high-speed dynamic or static random access memory (Dynamic Random-Access Memory (DRAM) or Static Random-Access Memory (SRAM)), and read-only memory. Access to the memory unit 570 by other components of the electronic device 500, such as the processor 550 and the storage 560, may be controlled by the electronic device 500. In some embodiments, the memory unit 570 may store an additional subset of the modules and data structures not described above.

The establisher 572 is for establishing the user profile 400 based on the service information request received by the input device 520. The reconfigurer 574 is used to reconfigure the service information in form of a layout arrangement based on the user profile. The layout arrangement may comprise a plurality of components as described earlier.

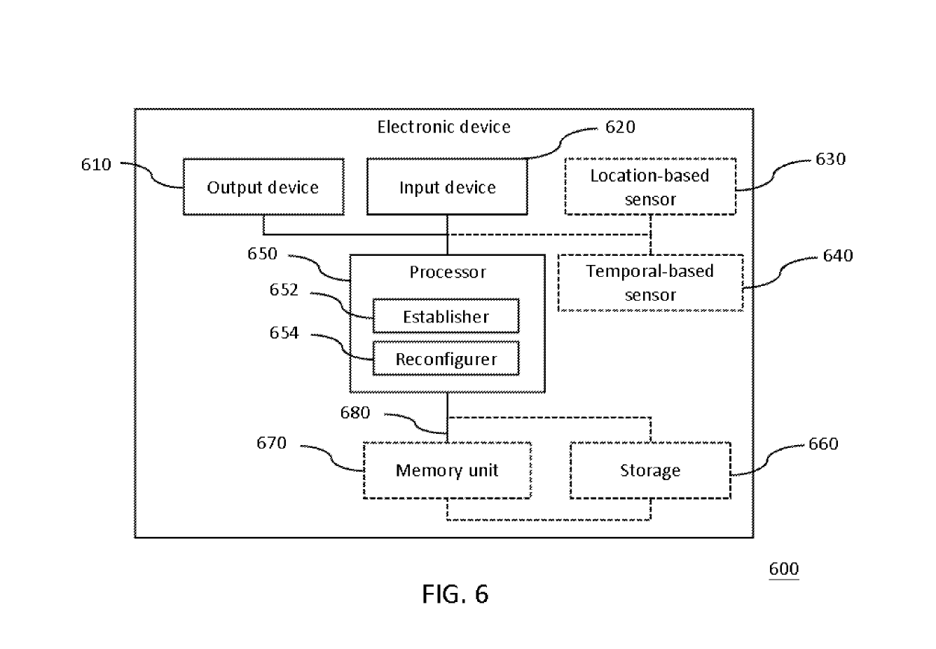

FIG. 6 is a block diagram of another electronic device 600 with BUILD system according to some other embodiments of the present disclosure. The electronic device 600 comprises an output device 610, an input device 620, and a processor 650 comprising an establisher 652 and a reconfigurer 654. The electronic device 600 may further comprise a location-based sensor 630, a temporal-based sensor 640, a storage 660, and a memory unit 670. These elements/devices may communicate over one or more communication buses or signal lines 680.

It should be appreciated that the electronic device 600 is only one example. The electronic device 600 may have more or fewer components than those shown in FIG. 6, may combine two or more elements/devices, or may have a different representation, configuration, or arrangement of the elements/devices. In other words, the elements/devices with dotted lines can be used or not based on the applications and scenarios. For example, when there is no need for the location and temporal information in a scenario, the location-based sensor 630 and the temporal-based sensor 640 can be hided or omitted. The electronic device 600 and the various elements/devices shown in FIG. 6 may be implemented in hardware, software, or a combination of both hardware and software, including one or more signal processing and/or application specific integrated circuits.

The output device 610 is used to present the aforementioned reconfigured service information. The output device 610 comprises any display device such as a screen of the electronic device 600, a television, a computer monitor, a head-mounted display, liquid crystals, a broadcast reference monitor, a medical monitor, a cathode ray tube display (CRT), a light-emitting diode display (LED), an electroluminescent display (ELD), an electronic paper (E-Ink), a plasma display panel (PDP), a liquid crystal display (LCD), a high-performance addressing display (HPA), a thin-film transistor display (TFT), an organic light-emitting diode display (OLED), a surface-conduction electron-emitter display (SED), laser TV, carbon nanotubes, a quantum dot display, an interferometric modulator display (IMOD), a swept-volume display, a varifocal mirror display, an emissive volume display, a laser display, a holographic display, and a light field display. Moreover, the output device 610 may comprise at least one display device or transmitter.

The input device 620 is for receiving the aforementioned service information request from the user. The input device 620 may comprise a touch panel, a mouse, a keyboard, a telecommunication receiver, a gesture recognizer, a voice receiver, a gyroscope, a camera, a ultrasound, a brainwave receiver, a software input (e.g., command, speech synthesis, and text-to-speech), and a combination thereof.

When the service information is location-based, the location-based sensor 630 is responsible for sensing the location of the user. The location-based sensor 630 may include a positioning system, such as a global navigation satellite systems (GNSS), a global positioning system (GPS), a global navigation satellite system, a Galileo, a Beidou navigation system, an Indian regional navigational satellite system, a regional system, a long range navigation system, a site-wide system, an active bat, a workspace system, a Wii Remote with sensor bar, a Polhemus Tracker, and an interplanetary-radio communication system. The location-based sensor 630 may get location information from another system like electronic cash registers (ECR) and point of sale (POS) as well.

When the service information is location-based, the temporal-based sensor 640 is used to sense time. The temporal-based sensor 640 may be implemented in the electronic device 600, such as a desktop computer, a laptop, a Smartphone, a tablet, and a portable device, or in another device, such as a watch and a clock. The temporal-based sensor 640 may further sense valid time, which is the time period during which a fact is true with respect to the real world, transaction time, which is the time period during which a fact stored in the database is considered to be true, and bitemporal data, which combines both valid and transaction time.

The processor 650 is used to execute program routines for the electronic device 600 and is electrically connected to the output device 610, the input device 620, and the memory unit 670. In some embodiments, the processor 650 and the memory unit 670 may be implemented on a single chip. They may be implemented on separate chips or separately put on individual devices in some other embodiments.

The establisher 652 is for establishing a user profile (e.g. the user profile 400) based on the service information request received by the input device 620.

The reconfigurer 654 is used to reconfigure the service information in form of a layout arrangement based on the user profile. The layout arrangement may comprise a plurality of components as described. The storage 660 is for storing user profile (e.g. the user profile 400). The storage 660 may comprise one or more non-volatile memory, magnetic disk storage devices, optical disk storage devices, flash memory devices, or other non-volatile solid state storage devices. The memory unit 670 stores the program routines. The memory unit 670 may include high-speed random access memory, random access memory, and read-only memory. Access to the memory unit 670 by other elements/devices of the electronic device 600, such as the processor 650 and the storage 660, may be controlled by the electronic device 600. In some embodiments, the memory unit 670 may store an additional subset of the modules and data structures not described above.

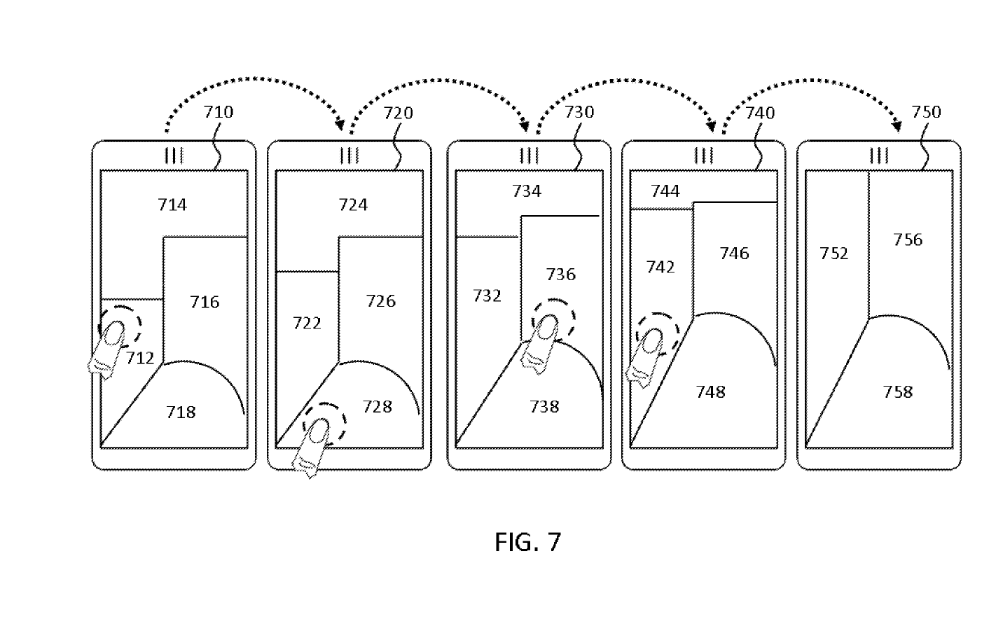

FIG. 7 is a diagram illustrating a set of sequential layout arrangements, in which some components are automatically resized and some are hidden according to service information request (e.g. touch actions). Initially, the layout arrangement 710 being with a set of four components 712, 714, 716, and 718 is displayed on a touch screen.

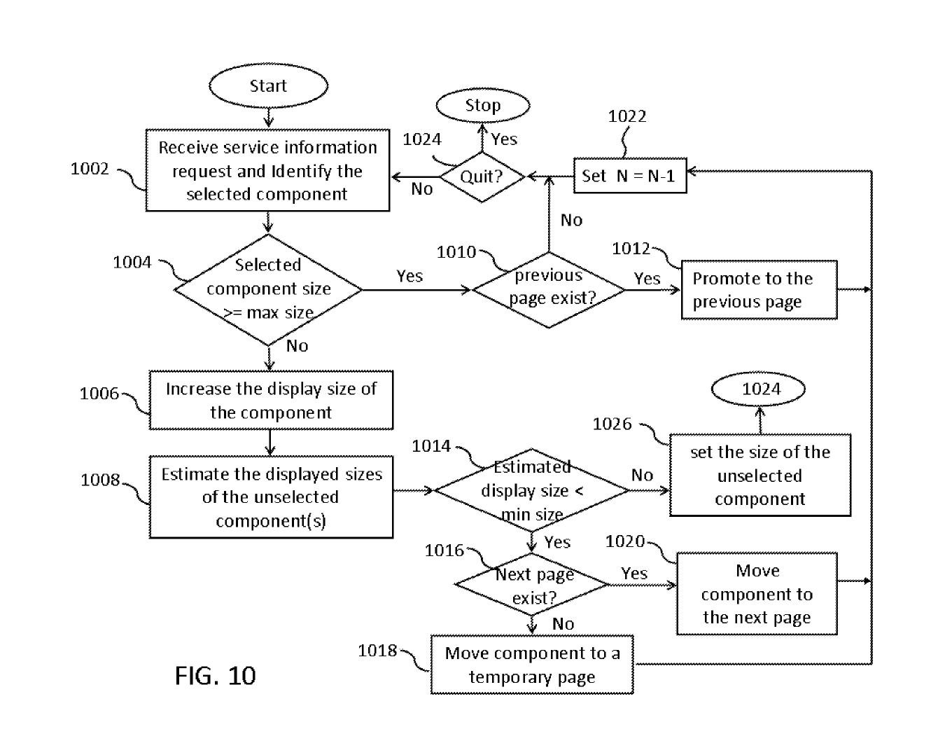

In this embodiment, a user touches the component 712 (as shown by a finger touched to a dashed circle) of the layout arrangement 710, which is treated as a service information request. According a resizing algorithm (e.g. the one shown in FIG. 10), the displayed size of the component 712 is automatically increased. It is noted that the resizing algorithm may be executed by the reconfigurer 574, the reconfigurer 654, or other device. The component 712 becomes the component 722 in the layout arrangement 720. The displayed size of the component 714, 716, and 718 are automatically reduced and the component 714 becomes component 724 (similarly, the component 716 becomes the component 726, and the component 718 becomes the component 728) in the layout arrangement 720. Likewise, the component 728 grows bigger and become the component 738 after the user's touch action triggering the resizing algorithm in the layout arrangement 720. The component 736 becomes the component 746 according to the same method when the component 736 in the layout arrangement 730 is touched. To sum up, after the user touches the component 712 of the layout arrangement 710 (i.e. a service information request is received), the reconfigured layout arrangement 720 comprising components 722, 724, 726, 728 is displayed.

Similarly, after the user touches the component 728 of the layout arrangement 720 (i.e. another service information request is received), the reconfigured layout arrangement 730 comprising components 732, 734, 736, 738 is displayed. The components 732, 734, 736, 738 respectively correspond to the components 722, 724, 726, 728. After the user touches the component 736 of the layout arrangement 730 (i.e. another service information request is received), the reconfigured layout arrangement 740 comprising components 742, 744, 746, 748 is displayed. It is noted that components 742, 744, 746, 748 respectively correspond to the components 732, 734, 736, 738. In other words, the algorithm (as shown in FIG. 10) allows the component whichever is being touched by the user to grow bigger, while the sizes of the rest untouched components will be shrunk.

After the user touches the component 742 in the layout arrangement 740 (i.e. another service information request is received), the resizing algorithm will calculate and decide hiding the component 744 because it is left unused for a period of time or it has been shrunk smaller than a predetermined minimal size. The layout arrangement 740 is reconfigured to the layout arrangement 750 including only three components 752, 756, and 758. It is noted that the components 752, 756, and 758, respectively correspond to the components 742, 746, and 748, all grow bigger due to the absence of the component 744.

In other embodiments, the components may be automatically resized and hidden in response to other input actions on the user interface (i.e. in response to other service information request). Various kinds of service information request have been described above, so are not repeated herein.

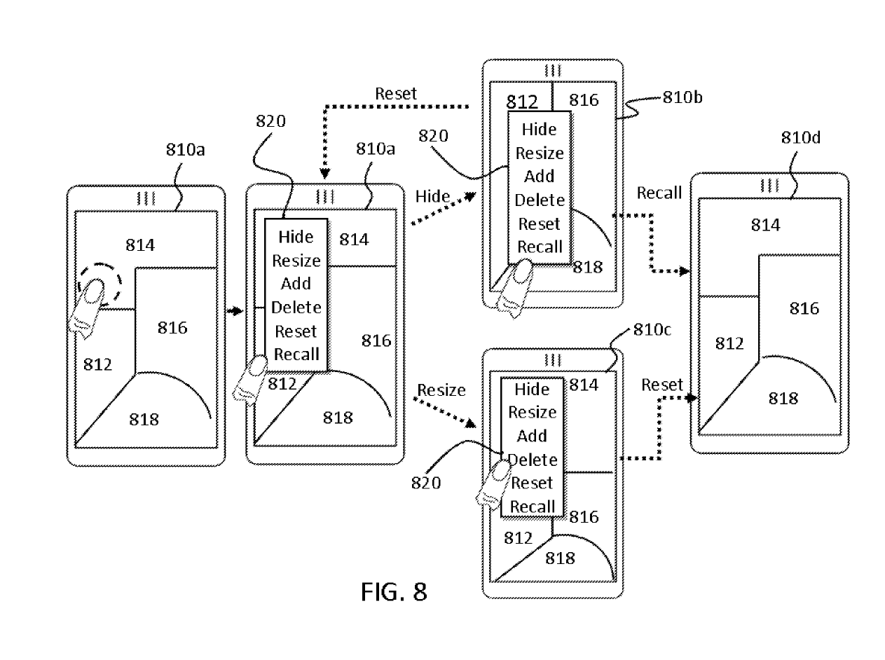

FIG. 8 shows an exemplary set of sequential layout arrangements created by the present disclosure, which may be created by the aforementioned method, the electronic devices 500, 600. In this example, a component of a layout arrangement is resized or hidden in a manual mode. In one embodiment, an electronic device (e.g. the electronic devices 500, 600) displays a layout arrangement 810a. In the beginning, the layout arrangement 810a includes a set of four components 812, 814, 816, and 818. The layout arrangement 810a on the user interface could be rearranged according to the user profile. When a user's finger touches the component 814 on the user interface, the electronic device receives a service information request. The received service information request comprises at least one of an action of hiding one of the components 812, 814, 816, and 818 from the layout arrangement 810a, adding a new component to the set of the components 812, 814, 816, and 818 of the layout arrangement 810a, resizing at least one of the components 812, 814, 816, and 818, deleting at least one of the components 812, 814, 816, and 818, resetting the layout arrangement 810a, and recalling at least one of hidden component. The user interface presents a pop-up menu 820 that comprises a list of candidate service information request (or options) to be chosen. In this example, the pop-up menu 820 displays the candidate service information requests (or options) linked to the reconfigurer 574 or the reconfigurer 654, such options include hiding, adding, resizing, deleting, resetting, and recalling. Upon selection of the service information request (or option) for hiding or resizing the component 814, the user interface transmits the corresponding component 814 and the selected request to the processor 550 or the processor 650. The reconfigurer 574 run on the processor 550 or the reconfigurer 654 comprised in the processor 650 reconfigures the layout arrangement 810 and places the hidden or resized component 814 in the storage 560 or the storage 660 (as shown in FIG. 5 or FIG. 6, respectively).

For the hiding case, upon selection of the service information request (or option) for hiding the component 814 from the layout arrangement 810a, the electronic device may display the reconfigured layout arrangement 810b comprising the components 812, 816, 818, wherein the component 814 is hidden from the reconfigured layout arrangement 810b. For the resizing case, upon selection of the service information request (or option) for resizing the layout arrangement 810a, the electronic device may display the reconfigured layout arrangement 810c comprising the components 812, 814, 816, 818, wherein the displayed sizes of the components 812, 814, 816, 818 from the layout arrangement 810a are different from the sizes of the components 812, 814, 816, 818 from the layout arrangement 810c. For the resetting case, upon selection of the service information request (or option) for resetting the layout arrangement 810c, the electronic device may display the reconfigured layout arrangement 810d, wherein the layout arrangement 810d is the same as the layout arrangement 810a. In other case, the layout arrangement 810c may be reset to other layout arrangement, which is any one of the previous layout arrangements or a default setting of an original layout arrangement. For the recalling case, upon selection of the service information request (or option) for recalling a hidden component of the layout arrangement 810b, the electronic device may display the reconfigured layout arrangement 810d that has the components 812, 814, 816, 818 including the component 814 that was hidden from the layout arrangement 810b.

When the user's finger touches the reconfigured layout arrangement 810b (or the reconfigured layout arrangement 810c), the user interface presents the pop-up menu 820 that comprises a list of candidate service information request again. In this example, the pop-up menu 820 displays the candidate service information requests linked to the reconfigurer 574 or the reconfigurer 654, including hiding, adding, resizing, deleting, resetting, and recalling. Upon selection of the service information request (or option) for resetting or recalling the component 814, the user interface transmits the selected service information request to the processor 550 or the processor 650. The reconfigurer 574 run on the processor 550 or the reconfigurer 654 of the processor 650 reconfigures the layout arrangement 810b (or the reconfigured layout arrangement 810c) to layout arrangement 810d which is identical to the initial layout arrangement 810a.

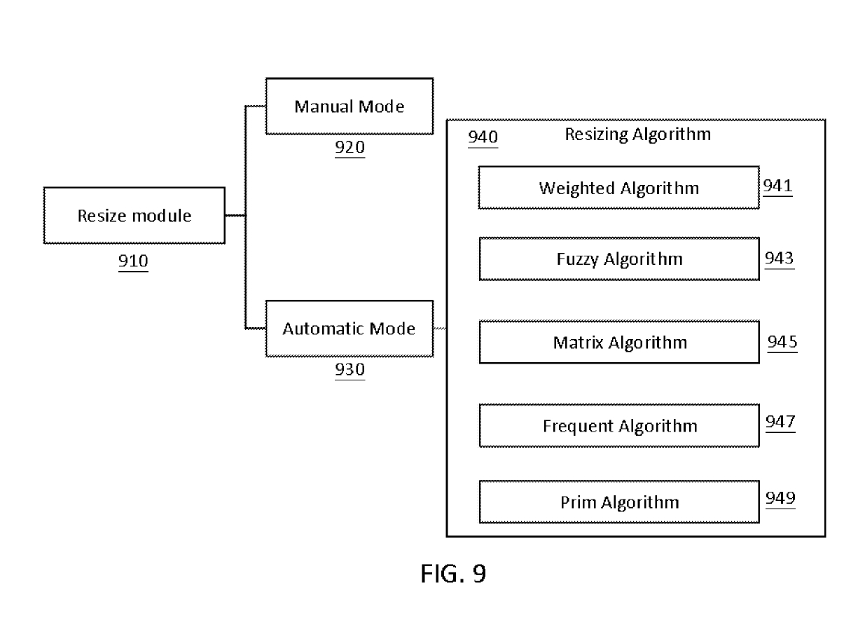

FIG. 9 illustrates an exemplary resizing process for updating at least one component (or components) of a layout arrangement. The resize module 910 can resize at least one of the components when updating the layout arrangement (i.e. when reconfiguring the service information based on user profile, which is established based on at least one service information request). As illustrated in FIG. 9, the resizing process can be invoked when a user desires to vary the relative size of selected component displayed on electronic device or the like. The resize module 910 can be further presented in two modes (i.e. the manual mode 920 and the automatic mode 930). At the manual mode 920, users can reset or redefine any displayed size or configuration in their own way manually, such as returning to the default size or a continuous resizing by triggering zoom in/out. The displayed size of a selected component can be determined based upon user behavior. Alternatively, a displayed size of the component can be executed in the other way by the automatic mode 930. The automatic mode 930 may provides various resizing algorithms 940 to achieve automatically resizing at least one component of a layout arrangement. The resizing algorithms 940 may include a weighted algorithm 941, a fuzzy algorithm 943, a matrix algorithm 945, a frequent algorithm 947, a prim algorithm 949, and/or the like.

Alternatively or additionally, components can be resized in the BUILD component space according to component's updating record in BUILD, such as data associated with the selected components. However, this resizing algorithm 940 is not limited to only the algorithms set forth within this disclosure. Rather, the generation of variable sized components of layout arrangements as shown in this disclosure is meant to be exemplary of many other algorithms and is for the purpose of providing automatically resizing of the components of layout arrangements. The resize module 910 may be embedded in a processing unit and may be able to record updating data in the user profile stored in the storage.

FIG. 10 is a flow diagram is an example for updating a displayed size of at least one components of a layout arrangement of service information. The process shown in FIG. 10 may cooperate with the process shown in FIG. 1.

In this example, a user can view N components at the beginning, which is called as the “Start” stage. It is noted that the variable N is a positive integer (for example N=10). The N components are used for computing by layout arrangement algorithm. BUILD system (e.g. the method, electronic devices 500, 600) receives a service information request (e.g. a user clicks one of the components) and identifies one of the components as a selected component according to the service information request (stage 1002). It is noted that the unselected components are identified once the selected component is identified.

Next, the method determines whether a displayed size of the selected component reaches a predetermined maximum size (stage 1004). If the displayed size of the selected component is smaller than the predetermined maximum size, then the next stage 1006 is executed for increasing the displayed size of the selected component from a first current size to a first target size.

For example, the displayed size of the selected component may be increased by X %, wherein the variable X is a number greater than zero. Afterwards, for each of the unselected components, an estimate is made of a displayed size of the unselected component by decreasing a second current size to a second target size (stage 1008). For example, the displayed size of each of the unselected component may be decreased by [X/(N−1)]%. In other words, this action will keep the overall display size unchanged.

On the contrary, if the displayed size of the selected component size is determined to be larger than or equal to the predetermined maximum size (i.e. the displayed size of the selected component size reaches the predetermined maximum size), then stage 1010 is executed to check the existence of a previous page of the service information. If the previous page of the service information exists, stage 1012 is executed to move the selected component form a current page of the service information to the previous page of the service information (i.e. promoting to the previous page). After promoting the selected component to the previous pages, N is updated by N−1 (stage 1022). Next, determining determination is made about whether to quit the procedure (stage 1024). If it is determined to quit, then the procedure stops. Otherwise, the algorithm goes back to stage 1002 again.

It is an option to promote the largest component from a lower page of service information (if there is one) to the current page of service information in order to keep the current display with N number of components (not shown in FIG. 10). Similarly, it is also possible to move the smallest component of the current page to a lower page (if there is one), if the current display has exceeded N number of components (not shown in FIG. 10). When moving a component from one page to another, the sizes of each of the components within that level/display are resized accordingly based on the same principle.

As mentioned, stage 1008 is executed for each of the unselected components for estimating a displayed size of the unselected component by decreasing a second current size to a second target size. After this stage, a check is made to determine if the estimated display size of any of the components (i.e. the second target sizes) is smaller than a predetermined minimum size (stage 1014). If there is no component whose displayed size is smaller than the predetermined minimum size, then stage 1026 is executed for each of the unselected components. That is, for each of the unselected component, stage 1026 sets the displayed size of the unselected component to the second target size when the second target size is not smaller than a predetermined minimum size. Afterwards, stage 1024 is executed.

Conversely, if the estimated displayed size (i.e. the second target size) of any unselected component is smaller than the predetermined minimum size, stage 1016 is executed for checking whether a next page of the service information exists or not. If next page does not exist, the unselected component whose estimated displayed size is smaller than the predetermined minimum size will be moved to a temporary page (i.e. hidden from the current page of the service information). Afterwards, the method proceeds to stage 1022. If stage 1016 determines that there is a next page of the service information, the unselected component whose estimated displayed size is smaller than the predetermined minimum size will be moved from the current page to the next page as mentioned before. Then, the method also proceeds to stage 1022.

It is noted in some other embodiments, the aforementioned stages 1008, 1014 may be omitted when a displayed size of an unselected component already reaches the predetermined minimum size. This is because the estimated displayed size of that unselected component will be definitely smaller than the predetermined minimum size. For these situations, stage 1016 will be directly executed.

According to the process shown in FIG. 10, the displayed size of the components and the number of components shown in each page of the service information can be calculated automatically with reference to a predetermined maximum size and a predetermined minimum size or a predetermined maximum and a predetermined minimum number of components within a display. A concrete example is given below. It is assumed that the predetermined maximum size is equal to 50% of the total displayed size and the predetermined minimum size is equal to 10% of the total displayed size. In this way, there should be at least 2 components (minimum number of components) in a layout arrangement because the displayed size of each component can not be greater than 50% of the total displayed size. In addition, there will be at most 10 components (maximum number of components) in the layout arrangement because each component cannot be smaller than 10% of the total displayed size.

Another example for updating a displayed size of at least one components of a layout arrangement is given herein.

Please refer to FIG. 7 again. The layout arrangement 710 corresponds to a set of four components 712, 714, 716, and 718. It is assumed that the displayed sizes of the layout arrangement 710 is 500 pixels and the displayed sizes of the components 712, 714, 716, and 718 are respectively 100 pixels, 160 pixels, 140 pixels, and 100 pixels.

The stage of reconfiguring the layout arrangement 710 into the layout arrangement 720 may comprise the following stages. First, the number of the components displayed to the user interface is determined. In this example, a set of four components (i.e. the components 712, 714, 716, and 718) within the layout arrangement 710 are displayed. A reduce component size (e.g. w=10 pixels, where the variable w indicates the reduce component size) is set. When the component 712 has been clicked for a predetermined click times (e.g. Clicks=3), the displayed size of the component will be increased (e.g. W=w*(component numbers−1)=30 pixels, wherein the variable W indicates the amount to be increased) and the displayed sizes of the unselected component 714, 716, and 718 will be reduced (w=10 pixels). Afterwards, the layout arrangement 720 is displayed and the displayed sizes of the components 722, 724, 726, 728 are respectively to be 130 pixels, 150 pixels, 130 pixels, and 90 pixels.

Yet another example for updating a displayed size of at least one components of a layout arrangement is given herein. This example estimates displayed size of a component by the method as addressed in the previous example. In addition, this example further determines whether the estimated displayed size is greater than a predetermined maximum size or smaller than a predetermined minimum size and performs the adjustments.

Please still refer to FIG. 7 again. The layout arrangement 740 corresponds to a set of four components 742, 744, 746, and 748. It is assumed that the displayed sizes of the layout arrangement 710 is 500 pixels and the displayed sizes of the components 742, 744, 746, and 748 are respectively 130 pixels, 90 pixels, 130 pixels, and 150 pixels.

The stage of reconfiguring the layout arrangement 740 into the layout arrangement 750 may comprise the following stages. First, the number of the components displayed to the user interface is determined. In this example, four components 742, 744, 746, and 748 (i.e. N=4) within a set of the layout arrangement 740 are displayed. A predetermined minimum size and a predetermined maximum size of the displayed size of a component are set (e.g. the predetermined minimum size may be set to 90 pixels and the predetermined maximum size may be set to 300 pixels).

When the component 748 has been clicked for a predetermined click times (e.g. Clicks=3), the displayed sizes of the components 742, 744, 746, and 748 will be updated. To be more specific, the displayed size of the component 744 is estimated to be 80 pixels (i.e. subtracting 10 pixels from 90 pixels leaves 80 pixels), which is smaller than the predetermined minimum size. Hence, the component 744 will be hidden, the components remained on the layout arrangement 750 are the components 752, 756, and 758. In this example, the displayed size of the component 744 will be distributed to the components 752, 756, and 758 according to the ratio of their displayed sizes. To be more specific, the displayed size of the component 752 is equal to 159 pixels

$$( i . e . 90 \times ( \frac{130}{130 + 130 + 150} ) + 130 \approx 159 ) ,$$

the displayed size of the component 756 is equal to 159 pixels

$$( i . e . 90 \times ( \frac{130}{130 + 130 + 150} ) + 130 \approx 159 ) ,$$

and the displayed size of the component 758 is equal to 182 pixels

$$( i . e . 90 \times ( \frac{150}{130 + 130 + 150} ) + 150 \approx 159 ) .$$

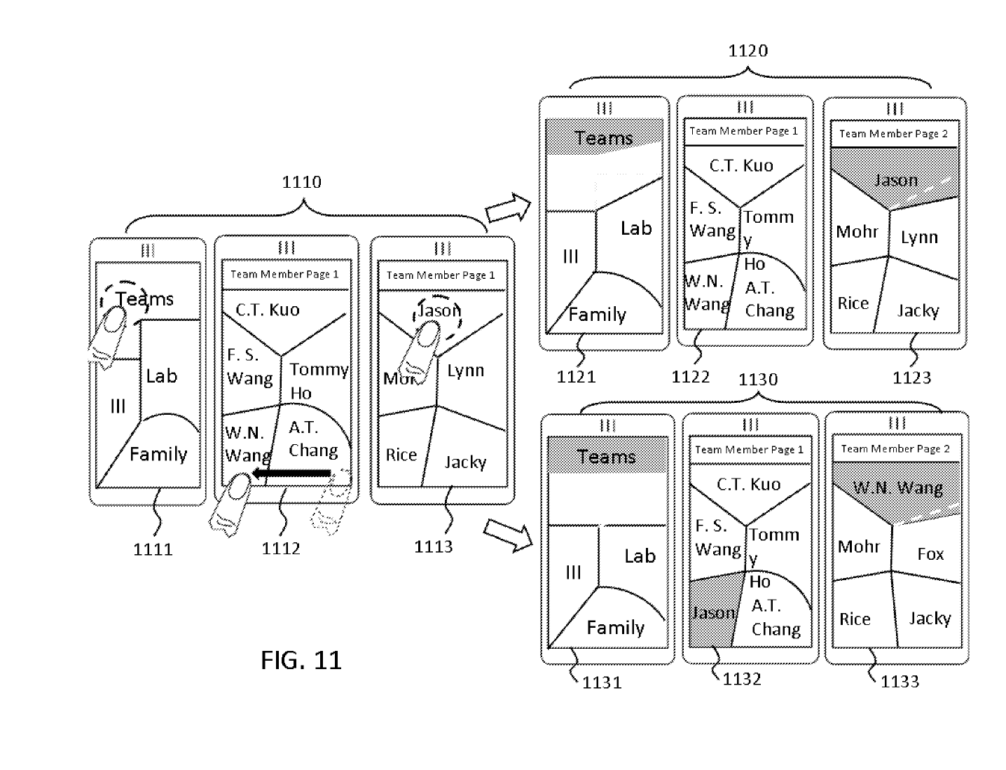

FIG. 11 is a diagram illustrating 3 sets of sequential layout arrangements 1110, 1120, 1130 regarding a service information according to an embodiment of the present disclosure. The layout arrangements 1110, 1120, 1130 are for a phone directory and displayed sizes of the components are adjusted in an automatic mode. From each of the layout arrangements 1110, 1120, 1130, it is learned that the service information has three pages.

In first set of layout arrangement 1110, initially, the phone directory is grouped into 4 category components including teams, Lab, III, and Family, as shown in the cover page 1111. There are some preset parameters in BUILD in this embodiment, including: the predetermined minimum component size is 15% of the total displayed size, the predetermined maximum component size is 40% of the total displayed size, the predetermined minimum number is 3, and the predetermined maximum number is 5. When the cover page 1111 of the service information is displayed, a user may click the component of “Teams” and the user interface then displays the first page 1112 of the layout arrangement 1110 (i.e. the next page of the cover page 1111 regarding the service information). In this example, team members, such as C. T. Kuo, F. S. Wang, Tommy Ho, W. N. Wang and A. T. Chang are displayed. However, if team members exceed maximum number of components for a display, the rest members are shown in the second page. The user may drag the display of the first page 1112 and move it to the second page 1113 (i.e. the next page of the first page 1112 regarding the service information). The user may find Jason, Lynn, Jacky, Rice and Mohr. The user makes a phone dial to Jack. After the user finished the dialing, the layout arrangement algorithm (e.g. the one shown in FIG. 9 or FIG. 10) will resize all the components located in the second page 1113.

In the second set of the layout arrangement 1120, the displayed size of the component “Teams” is enlarged as shown in the cover page 1121 because of the previous dialing to Jason, and the displayed size of the component “Jason” is also enlarged as shown in the second page 1123. As shown in the first page 1122 and the second page 1123, the number of the components shown in each page reaches the predetermined maximum number (i.e. 5).

In the third set of the layout arrangement 1130, if more clicks on component “Jason”, when its size is greater than the predetermined maximum size it will be promoted to the first page 1132 and the less frequently clicked component “W. N. Wang” is demoted to the second page 1133 to allow the component “Jason” in the second page 1123 to move in. To be more specific, the present invention identifies the component “Jason” as a selected component according to the service information request (i.e. the user's clicks) and swaps the selected component (i.e. the component “Jason”) of one page of the service information with a minimum component (i.e. the component “W. N. Wang”) from another page of the service information because a displayed size of the selected component reaches a predetermined maximum size. In this case, Jason and W. N. Wang are swapped.

In addition, the present invention may swap components from another angle. After the present invention identifies the component “Jason” as the selected component, the present invention may also analyze other components.

To be more specific, when a displayed size of an unselected component (e.g. the component “Lynn”) reaches a predetermined minimum size, the present invention swaps the unselected component of this page of the service information with a maximum component (e.g. the component “Fox”) from another page of the service information. In this case, the component “Fox” is promoted from a third page (not shown) to the second page 1133 while component “Lynn” is demoted.

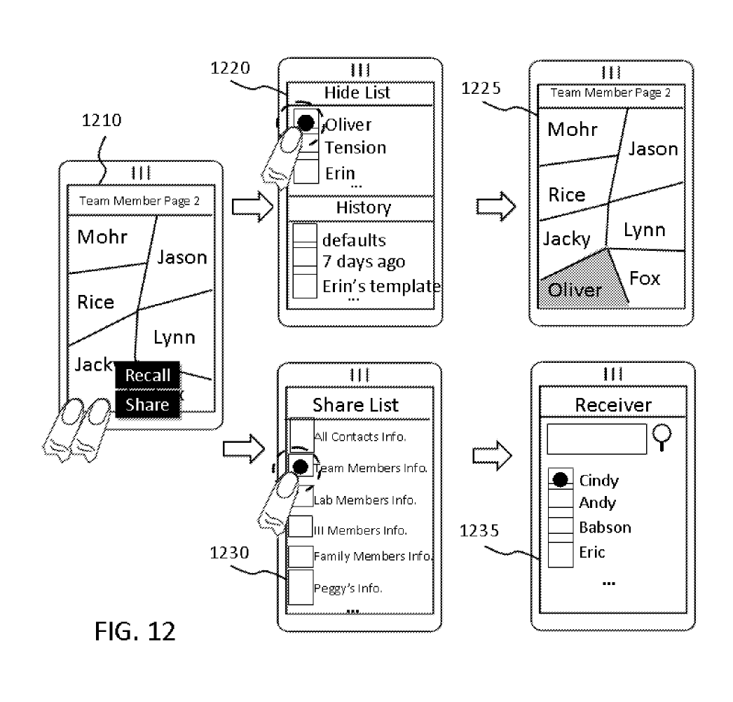

FIG. 12 is a set of diagrams illustrating layout arrangements 1210, 1220, 1225, 1230, 1235 for a phone directory embodiment for recall and share action in a manual mode. More specifically, it shows a user scenario for recall and share in the BUILD based phone directory embodiment. In the layout arrangement 1210, a user can double click the user interface to display a manual including a recall function and a share function. If the user clicks the recall function, the layout arrangement 1220 is displayed to show a hide list to recall component(s) parked in the list. If the user clicks the component “Oliver”, the layout arrangement 1225 comprising the component “Oliver” will be displayed.

In addition, the layout arrangement 1220 further comprises a history list, such as the default contact list, 7 days ago history, or other user shared template for user to access for more recall listed.

When the layout arrangement 1210 is displayed, the user may also click the share function to share the stored user profile as shown in the layout arrangement 1230. The information that can be shared includes all contacts information, Team Members information, Lab Members Info., III Members Info, Family Members Info, Peggy's information, etc. If the user chooses Team Members information, the layout arrangement 1235 is displayed for showing members with the BUILD system may receive your shared information.

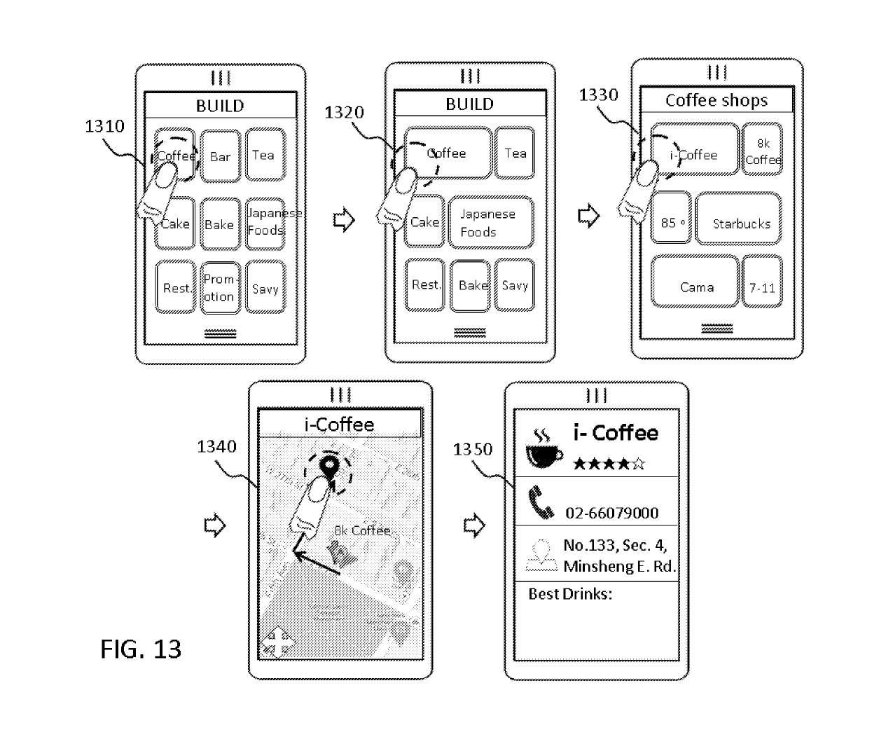

FIG. 13 is a set of diagrams showing layout arrangements 1310, 1320, 1330, 1340, 1350 of a location-based service information embodiment. More specifically, it shows an example of a user setup BUILD program for foods and restaurants application with location based service. The layout arrangement 1310 comprises category components of food stores and restaurants where the user has been queried for a period of time are shown. The layout arrangement 1310 includes components such as Coffee, bar, Tea, Cake, Bake, Japanese Foods, Rest, Promotion and Savy, etc. After the user queries some coffee shops and Japanese Foods in this application for a period of time, the BUILD can recognize his/her clicks and enlarge the sizes of the component “coffee” and the component “Japanese Foods” and reduce the sizes of the other components as shown in the layout arrangement 1320. When the user clicks the component “coffee” shown in the layout arrangement 1320, the application provides relevant information within a predefined distance (e.g. coffee shops within 5 km of user's location) as shown in the layout arrangement 1330. It is called location-based service. The layout arrangement 1330 shows the user's preference such as i-coffee, Starbucks, and Cama and the size of these components are larger than the others. After the user clicks the component “i-coffee” in the layout arrangement 1330, the BUILD delivers the layout arrangement 1340 which is a location-surrounding map. It provides the navigation information of i-coffee. When the user clicks on the location of i-coffee, the layout arrangement 1350 is displayed which shows i-coffee store information, such as ranking, phone number, address, and best drinks, etc.

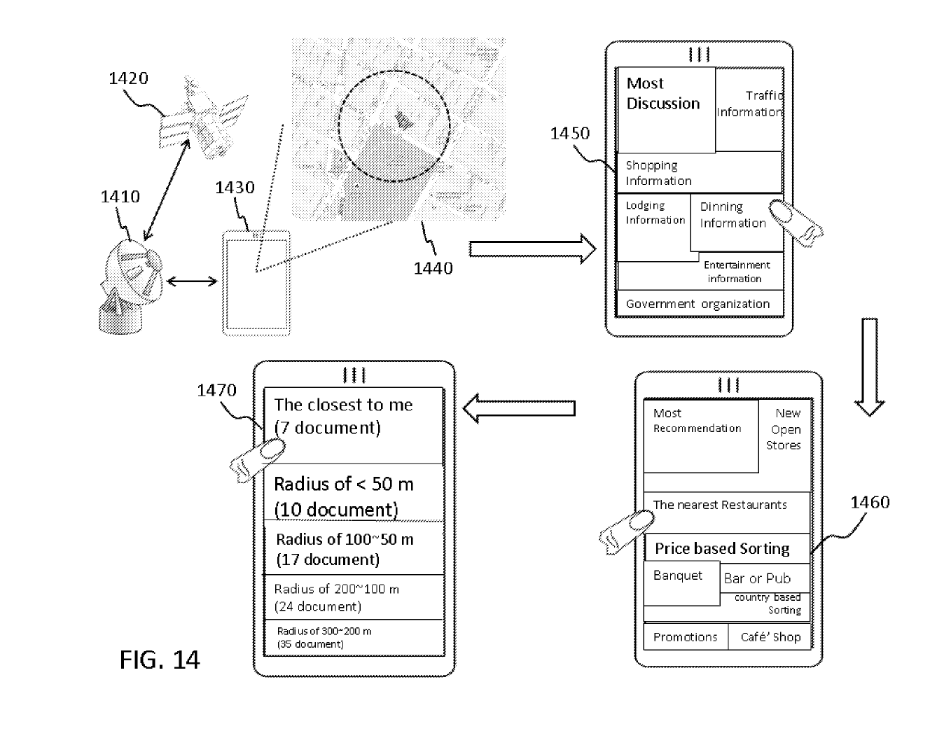

FIG. 14 is a set of sequential diagrams showing layout arrangements 1450, 1460, 1470 of location-based service according to another embodiment of the present embodiments. In this embodiment, a base station 1410 can receive data from a user via a GPS artificial satellite 1420. It can transfer the location-based service information to user's electronic device 1430 which equipped with BUILD. The base station 1410 also delivers a location-surrounding map 1440 and its service/information to the user. The display of the electronic device will show the service/information in form of a layout arrangement 1450 wherein the user can capture some local information for such examples in the categories as ‘Most discussion’, ‘Traffic’, ‘Shopping information’, ‘Dinning information’, ‘Lodging information’, ‘Entertainment information’, and ‘Government organization’, etc. If user clicking on the component of ‘Dinning information’ from the layout arrangement 1450, the information in the next level of the selected component will be displayed as shown in the layout arrangement 1460. For example, it includes most recommendation, new open stores, the nearest restaurants, price based sorting, banquet, bar or pub, country based sorting, promotion, café's shop, etc. From the layout arrangement 1460, for example the user now clicks on ‘the nearest restaurants’. It will jump to another layout arrangement 1470, where user can read restaurant information based distance from user's current location. For example, the most nearby one to the user will be presented with the largest component in the screen.

According to the above descriptions, the present disclosure provides methods, systems, electronic devices, and non-transitory computer readable storage media for BUILD. With the present disclosed embodiments, service information is displayed to a user interface in form of a layout arrangement with a set of variable-sized components. That is, the displayed size of each of the components is variable and is varied according to the behavior of users. Hence, a more user-friendly environment is provided.

The above disclosure is related to the detailed technical contents and inventive features thereof. People skilled in this field may proceed with a variety of modifications and replacements based on the disclosed embodiments as described without departing from the characteristics thereof. Nevertheless, although such modifications and replacements are not fully disclosed in the above descriptions, they have substantially been covered in the following claims as appended.

What is claimed is:

1. A method for behavior based user interface layout display (BUILD), comprising:
displaying service information on a user interface in the form of a first layout arrangement with a first set of components;
receiving a service information request from the user interface;
establishing a user profile based on the service information request;
reconfiguring the service information based on the user profile; and
displaying the reconfigured service information on the user interface in the form of a second layout arrangement with a second set of components,
wherein a size of each of the first set and the second set of components is variable.

2. The method for behavior based user interface layout display of claim 1, wherein each of the first layout arrangement and the second layout arrangement is presented with at least one category.

3. The method for behavior based user interface layout display of claim 1, wherein each of the first layout arrangement and the second layout arrangement is presented with at least one hierarchical level.

4. The method for behavior based user interface layout display of claim 1, wherein the service information request is selected from the group consisting of a physical operation on the user interface, a user-behavior request, a sensing action performed by a sensor, and a combination thereof.

5. The method of behavior based user interface layout display of claim 1, wherein reconfiguring the service information comprises:
identifying one of the components of the first set as a selected component according to the service information request; and
swapping an unselected component of a first page of the service information, when a displayed size of the unselected component reaches a predetermined minimum size, with a maximum component from a second page of the service information.

6. The method of behavior based user interface layout display of claim 1, wherein reconfiguring the service information comprises:
identifying one of the components of the first set as a selected component according to the service information request; and
swapping the selected component of a first page of the service information, when a displayed size of the selected component reaches a predetermined maximum size, with a minimum component from a second page of the service information.

7. The method of behavior based user interface layout display of claim 1, wherein reconfiguring the service information comprises:
identifying one of the components of the first set as a selected component according to the service information request; and
moving the selected component from a first page of the service information, when a displayed size of the selected component reaches a predetermined maximum size, to a second page of the service information.

8. The method of behavior based user interface layout display of claim 1, wherein reconfiguring the service information comprises:
identifying one of the components of the first set as a selected component according to the service information request; and
moving an unselected component from a first page of the service information, when a displayed size of the unselected component reaches a predetermined minimum size, to a second page of the service information.

9. The method of behavior based user interface layout display of claim 1, wherein reconfiguring the service information comprises:
identifying one of the components of the first set as a selected component according to the service information request; and
increasing a displayed size of the selected component from a first current size to a first target size when the first current size is smaller than a predetermined maximum size.

10. The method of behavior based user interface layout display of claim 9, wherein reconfiguring the service information further comprises:
identifying an unselected component according to the service information request;
estimating a displayed size of the unselected component by decreasing a second current size to a second target size; and
setting the displayed size of the unselected component to the second target size when the second target size is not smaller than a predetermined minimum size.

11. The method of behavior based user interface layout display of claim 9, wherein reconfiguring the service information further comprises:
identifying an unselected component according to the service information request;
estimating a displayed size of the unselected component by decreasing a second current size to a second target size; and
hiding the unselected component from a page of the service information when the second target size is smaller than a predetermined minimum size.

12. The method for behavior based user interface layout display of claim 1, wherein the components are presented in different colors within the user interface.

13. The method for behavior based user interface layout display of claim 1, wherein the components are presented in different gray scales within the user interface.

14. The method for behavior based user interface layout display of claim 1, further comprising:
hiding at least one of the components on the user interface according to the reconfigured service information.

15. The method for behavior based user interface layout display of claim 1, further comprising:
adding a new component to the user interface according to the reconfigured service information.

16. The method for behavior based user interface layout display of claim 1, further comprising:
resizing at least one of the components on the user interface according to the reconfigured service information.

17. The method for behavior based user interface layout display of claim 1, further comprising:
deleting at least one of the components on the user interface according to the reconfigured service information.

18. The method for behavior based user interface layout display of claim 1, wherein the service information request is selected from the group consisting of hiding one of the components of the first set, adding a new component to the first set, resizing one of the components of the first set, deleting one of the components from the first set, recalling a hidden component, and a combination thereof.

19. The method for behavior based user interface layout display of claim 1, further comprising:
storing the user profile in a storage, wherein the user profile comprises one of a user action record, a reconfigure record, a component status record, a layout arrangement description, and a combination thereof.

20. The method for behavior based user interface layout display of claim 19 further comprising sharing the user profile.

21. The method for behavior based user interface layout display of claim 1, wherein the service information comprises at least one piece of location-based, temporal-based, social-based, and event-based service information.

22. An electronic device with behavior based user interface layout display, comprising:
an input device for receiving a service information request;
a memory unit for storing a plurality of program routines including:
an establisher for establishing a user profile based on the service information request; and
a reconfigurer for reconfiguring a service information in form of a layout arrangement based on the user profile;
an output device for presenting the reconfigured service information; and
a processor coupled to the input device, the output device, and the memory unit for executing the program routines.

23. The electronic device with behavior based user interface layout display of claim 22, wherein the layout arrangement is with a set of components to be presented on the output device and the reconfigurer further performs operations comprising:
identifying one of the components of the first set as a selected component according to the service information request; and
swapping an unselected component of a first page of the service information, when a displayed size of the unselected component reaches a predetermined minimum size, with a maximum component from a second page of the service information.

24. The electronic device with behavior based user interface layout display of claim 22, wherein the layout arrangement is with a set of components to be presented on the output device and the reconfigurer further performs operations comprising:
identifying one of the components of the first set as a selected component according to the service information request; and
swapping the selected component of a first page of the service information, when a displayed size of the selected component reaches a predetermined maximum size, with a minimum component from a second page of the service information.

25. The electronic device with behavior based user interface layout display of claim 22, wherein the layout arrangement is with a set of components to be presented on the output device and the reconfigurer further performs operations comprising:
identifying one of the components as a selected component according to the service information request; and
moving the selected component from a first page of the service information to a second page of the service information when a displayed size of the selected component reaches a predetermined maximum size.

26. The electronic device with behavior based user interface layout display of claim 22, wherein the layout arrangement is with a set of components to be presented on the output device and the reconfigurer further performs operations comprising:
identifying one of the components as a selected component according to the service information request; and
moving an unselected component from a first page of the service information to a second page of the service information when a displayed size of the unselected component reaches a predetermined minimum size.

27. The electronic device with behavior based user interface layout display of claim 22, wherein the service information corresponds to a set of components to be presented on the output device and the reconfigurer further performs operations comprising:
identifying one of the components of the set as a selected component according to the service information request; and
increasing a displayed size of the selected component from a first current size to a first target size when the first current size is smaller than a predetermined maximum size.

28. The electronic device with behavior based user interface layout display of claim 27, wherein the reconfigurer further performs operations comprising:
identifying an unselected component according to the service information request;
estimating a displayed size of the unselected component by decreasing a second current size to a second target size; and
setting the displayed size of the unselected component to the second target size when the second target size is not smaller than a predetermined minimum size.

29. The electronic device with behavior based user interface layout display of claim 27, wherein the reconfigurer further performs operations comprising:
identifying an unselected component according to the service information request;
estimating a displayed size of the unselected component by decreasing a second current size to a second target size; and
hiding the unselected component from a page of the service information when the second target size is smaller than a predetermined minimum size.

30. The electronic device with behavior based user interface layout display of claim 22, further comprising a storage unit for storing the user profile.

31. The electronic device with behavior based user interface layout display of claim 22, further comprising a location-based sensor for sensing a location to generate the service information, wherein the service information is location-based service information.

32. The electronic device with behavior based user interface layout display of claim 22, further comprising a temporal-based sensor for sensing a piece of temporal information to generate the service information, wherein the service information is temporal-based service information.

33. An electronic device with behavior based user interface layout display, comprising:
an input device for receiving a service information request;
a processor coupled to the input device and comprising:
an establisher for establishing a user profile based on the service information request; and
a reconfigurer for reconfiguring a service information in form of a layout arrangement based on the user profile; and
an output device coupled to the processing and for presenting the reconfigured service information.

34. The electronic device with behavior based user interface layout display of claim 33, wherein the layout arrangement is with a set of components to be presented on the output device and the reconfigurer further performs operations comprising:
identifying one of the components of the first set as a selected component according to the service information request; and
swapping an unselected component of a first page of the service information, when a displayed size of the unselected component reaches a predetermined minimum size, with a maximum component from a second page of the service information.

35. The electronic device with behavior based user interface layout display of claim 33, wherein the layout arrangement is with a set of components to be presented on the output device and the reconfigurer further performs operations comprising:
identifying one of the components of the first set as a selected component according to the service information request; and
swapping the selected component of a first page of the service information, when a displayed size of the selected component reaches a predetermined maximum size, with a minimum component from a second page of the service information.

36. The electronic device with behavior based user interface layout display of claim 33, wherein the layout arrangement is with a set of components to be presented on the output device and the reconfigurer further performs operations comprising:
identifying one of the components as a selected component according to the service information request; and
moving the selected component from a first page of the service information to a second page of the service information when a displayed size of the selected component reaches a predetermined maximum size.

37. The electronic device with behavior based user interface layout display of claim 33, wherein the layout arrangement is with a set of components to be presented on the output device and the reconfigurer further performs operations comprising:
identifying one of the components as a selected component according to the service information request; and
moving an unselected component from a first page of the service information to a second page of the service information when a displayed size of the unselected component reaches a predetermined maximum size.

38. The electronic device with behavior based user interface layout display of claim 33, wherein the service information corresponds to a set of components to be presented on the output device and the reconfigurer further performs operations comprising:
identifying one of the components of the set as a selected component according to the service information request; and
increasing a displayed size of the selected component from a first current size to a first target size when the first current size is smaller than a predetermined maximum size.

39. The electronic device with behavior based user interface layout display of claim 38, wherein the reconfigurer further performs operations comprising:
identifying an unselected component according to the service information request;
estimating a displayed size of the unselected component by decreasing a second current size to a second target size; and
setting the displayed size of the unselected component to the second target size when the second target size is not smaller than a predetermined minimum size.

40. The electronic device with behavior based user interface layout display of claim 38, wherein the reconfigurer further performs operations comprising:
identifying an unselected component according to the service information request;
estimating a displayed size of the unselected component by decreasing a second current size to a second target size; and
hiding the unselected component from a page of the service information when the second target size is smaller than a predetermined minimum size.

41. The electronic device with behavior based user interface layout display of claim 33, further comprising a storage unit for storing user profile.

42. The electronic device with behavior based user interface layout display of claim 33, further comprising a location-based sensor for sensing a location to generate the service information, wherein the service information is location-based service information.

43. The electronic device with behavior based user interface layout display of claim 33, further comprising a temporal-based sensor for sensing a piece of temporal information to generate the service information, wherein the service information is temporal-based service information.

44. A non-transitory computer readable storage medium storing program routines for causing an electronic device to perform a method, comprising:
displaying service information on a user interface in the form of a first layout arrangement;
receiving a service information request from the user interface;
establishing a user profile based on the service information request;
reconfiguring the service information based on the user profile; and
displaying the reconfigured service information on the user interface in the form of a second layout arrangement.
